(19) United States
(12) Patent Application Publication
(10) Pub. No.: US 2015/0056443 A1
(43) Pub. Date: Feb. 26, 2015

(54) Adhesive Composition and Article

(71) Applicant: Tyco Electronics Corporation, Berwyn, PA (US)

(72) Inventors: Lei Wang, San Jose, CA (US); Hyo Chang Yun, Saratoga, CA (US); David A. Hurrell, San Mateo, CA (US)

(73) Assignee: Tyco Electronics Corporation, Berwyn, PA (US)

(21) Appl. No.: 14/010,386

(22) Filed: Aug. 26, 2013

(51) Int. Cl. C09J 127/20

(52) U.S. Cl. CPC C09J 127/20
USPC 428/355 EN; 525/199

(57) ABSTRACT

An adhesive composition blend and an article are disclosed. The adhesive composition blend includes a higher-melt fluoropolymer component having a melting point greater than a predetermined maximum service temperature and a lower-melt fluoropolymer component having a melting point less than a predetermined applying temperature. The melting point of the higher-melt fluoropolymer is at least 20° C. greater than the melting point of the lower-melt fluoropolymer. Additionally or alternatively, the adhesive composition blend includes a higher-melt fluoropolymer component having a melting point between about 200° C. and about 330° C. and a lower-melt fluoropolymer component having a melting point between about 100° C. and about 260° C. The article includes a substrate and the adhesive.

### FIELD OF THE INVENTION

The present invention is directed to adhesives and articles having adhesives. More particularly, the present invention is directed to multi-component adhesive composition blends and articles including such blends.

### BACKGROUND OF THE INVENTION

Adhesives are used in a variety of environments for a variety of applications. Such environments and applications require adhesives to have specific temperature profiles, viscosity profiles, chemical and flammable resistant profiles, and adhesion characteristics. Known adhesives do not adequately meet all of these requirements.

In wiring applications, adhesives can be used with fluoropolymers. Fluoropolymers have low surface energy, for example, below 25 dynes/cm. This low surface energy makes it difficult for an adhesive to bond to the fluoropolymer. Surface treatments can ameliorate this; however, surface treatments present other problems and are often not available in repair conditions. For example, chemical etching or high energy plasma treatment can be used to activate a fluoropolymer surface. However, etching chemicals (such as sodium naphthalene) cannot be used in a repair area due to the toxicity and flammability. Also, plasma equipment is not able to be used due to the crowded nature of a repair area.

Polytetrafluoroethylene surfaces can be especially difficult for adhesion. Certain polymeric materials are unable to diffuse into the surface, thereby resulting in a lack of adhesion. Polymeric materials that are able to diffuse into the surface may not have desired properties. For example, such materials may drip and/or have melting points being below a maximum service temperature.

Current adhesives do not desirably bond to polytetrafluoroethylene (PTFE). Positioning current adhesives in contact with a surface having PTFE creates a microgap and/or delamination between the adhesive and the PTFE surface.

Certain polymers can provide adhesion to fluoropolymers by having similar chemical structures, relatively low surface energies, and low melting points. Such polymers can have desirable flow and wet-ability on the fluoropolymers. However, such low melting temperatures result in dripping issues in high service temperature applications, such as aerospace applications. The dripping issues can cause seal failure.

An adhesive composition blend and article having an adhesive composition blend that do not suffer from one or more of the above drawbacks would be desirable in the art.

### BRIEF DESCRIPTION OF THE INVENTION

In an exemplary embodiment, an adhesive composition blend includes a higher-melt fluoropolymer component having a melting point greater than a predetermined maximum service temperature and a lower-melt fluoropolymer component having a melting point less than a predetermined applying temperature. The melting point of the higher-melt fluoropolymer is at least 20° C. greater than the melting point of the lower-melt fluoropolymer.

In another exemplary embodiment, an adhesive composition blend includes a higher-melt fluoropolymer component having a melting point between about 200° C. and about 330° C. and a lower-melt fluoropolymer component having a melting point between about 100° C. and about 260° C. The melting point of the higher-melt fluoropolymer is at least 20° C. greater than the melting point of the lower-melt fluoropolymer.

In another exemplary embodiment, an article includes a substrate and an adhesive positioned on the substrate. The adhesive includes a higher-melt fluoropolymer component having a melting point greater than a predetermined maximum service temperature and a lower-melt fluoropolymer component having a melting point less than a predetermined applying temperature. The melting point of the higher-melt fluoropolymer is at least 20° C. greater than the melting point of the lower-melt fluoropolymer.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a schematic view of an article having an adhesive on a substrate according to an embodiment of the disclosure.

### DETAILED DESCRIPTION OF THE INVENTION

Provided is an exemplary adhesive composition blend and article having the adhesive composition blend. Embodiments of the present disclosure, for example, in comparison to articles and adhesives that do not include one or more of the features disclosed herein, are capable of use in specific temperature profiles, are capable of having predetermined viscosity profiles, have high adhesion characteristics (for example, with low surface energy surfaces), increased chemical resistance (for example, with low surface energy surfaces), increased dripping resistance (for example, with low surface energy surfaces), reduced or eliminated flammability, increased service temperature, or a combination thereof.

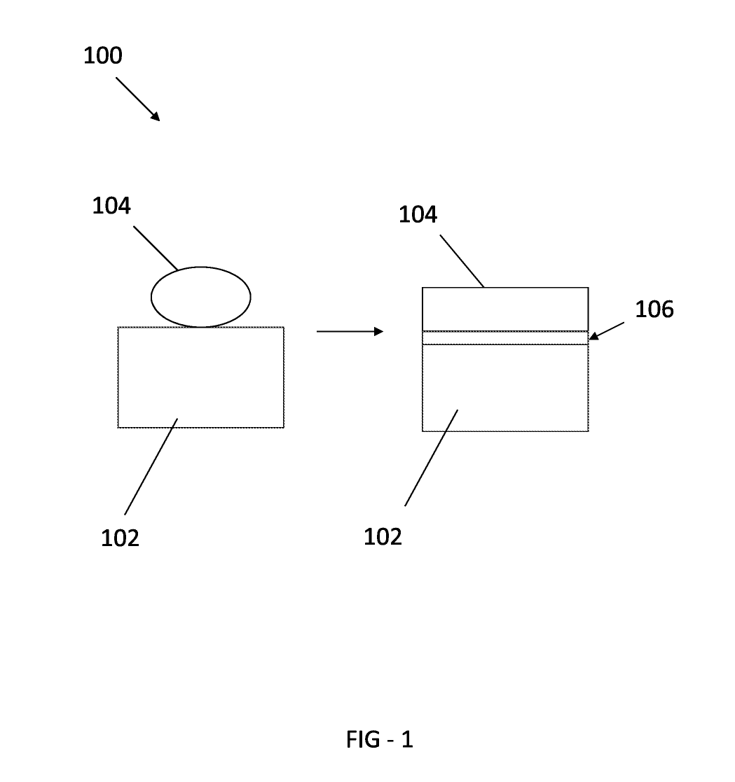

Referring to FIG. 1, in one embodiment, an article 100 includes a substrate 102 and an adhesive 104. The adhesive 104 penetrates into a diffusion region 106 of the substrate 102. The article 100 includes any suitable material permitting the adhesive 104 to be secured to the article 100. Suitable materials include, but are not limited to, aluminum, ethylene tetrafluoroethylene wire, a fluoropolymer, tape, heat-recoverable tubing (for example, 200° C. heat-recoverable tubing), mold parts, metal surfaces, wire, cable, tubing, and combinations thereof.

The adhesive 104 is applied to the substrate 102 at any suitable temperature for any suitable duration. Suitable temperatures include, but are not limited to, about 200° C., about 250° C., about 300° C., between about 200° C. and about 300° C., between about 300° C. and about 350° C., or any suitable combination, sub-combination, range, or sub-range therein. Suitable durations include, but are not limited to, between about 1 minute and about 20 minutes.

The adhesive 104 includes properties corresponding to the desired application, for example, having resistance to fluids (including or not including ketones), being wettable on perfluoropolymer substrates, other suitable properties, or a combination thereof. In one embodiment, the adhesive 104 has dimensional stability at about 250° C. and/or remains substantially devoid of phase separation after eight months at a temperature of about 250° C. In one embodiment, the adhesive 104 has a predetermined slip resistance, for example, greater than about 9 kilograms. In one embodiment, the adhesive 104 has aging resistance of 1000 hours of heat aging at 200° C. and 260° C.

The adhesive 104 adheres to the substrate 102 in response to a predetermined force, such as through a drum test that is close to a 90-degree peel test, a lab shear test, or a lab peel test that is a 180-degree test. In one embodiment, for example, with the substrate 102 being the aluminum, the predetermined force is about 4 kilograms per centimeter, about 5 kilograms per centimeter, any suitable force as is described below with reference to the Examples in Tables 1 and 2, or any suitable combination, sub-combination, range, or sub-range therein. In one embodiment, for example, with the substrate 102 being the ethylene tetrafluoroethylene wire, the predetermined force is about 7 kilograms per centimeter, about 8 kilograms per centimeter, about 9 kilograms per centimeter, any suitable force as is described below with reference to the Examples in Tables 1 and 2, or any suitable combination, sub-combination, range, or sub-range therein.

The adhesive 104 includes a higher-melt component and a lower-melt component. The higher-melt component is at a concentration, by volume, of less than 100%, for example, between about 1% and about 99%, between about 10% and about 50%, at about 10%, at about 50%, any concentration disclosed below with reference to the Examples in Tables 1 and 2, or any suitable combination, sub-combination, range, or sub-range therein. The lower-melt component is at a concentration, by volume, of less than 100 percent, for example, between about 1% and about 99%, between about 50% and about 90%, at about 50%, at about 90%, any concentration disclosed below with reference to the Examples in Tables 1 and 2, or any suitable combination, sub-combination, range, or sub-range therein.

The higher-melt component has a melting point that is greater than a maximum service temperature, for example, about 225° C., about 240° C., about 260° C., about 280° C., about 300° C., about 320° C., or any suitable combination, sub-combination, range, or sub-range therein. Additionally or alternatively, in one embodiment, the melting point is lower than the applying temperature, such as, by at least about 30° C., by between about 10° C. and about 40° C., by between about 10° C. and about 30° C., by between about 20° C. and about 40° C., by between about 20° C. and about 30° C., or any suitable combination, sub-combination, range, or sub-range therein. The lower-melt component has a melting point that is less than the applying temperature, for example, about 100° C., about 115° C., about 130° C., about 145° C., about 170° C., about 195° C., about 200° C., or any suitable combination, sub-combination, range, or sub-range therein. In one embodiment, the melting point of the higher-melt component and/or the melting point of the lower-melt component correspond with a predetermined repair temperature, a predetermined operational temperature, a predetermined cross-link temperature, or a combination thereof.

The higher-melt component and the lower-melt component are different materials. In one embodiment, the higher-melt component is or includes tetrafluoroethylene-co-hexafluoropropylene-co-vinylidene fluoride terpolymer (hereinafter “THV”), polyvinylidene, ethylene tetrafluoroethylene, fluorinated ethylene-propylene, any suitable thermoplastic fluoropolymer, any suitable thermoset elastomer, or a combination thereof. In one embodiment, the lower-melt component is or includes THV, terpolymer of ethylene, tetrafluoroethylene, and hexafluoropropylene (“EFEP”), polyvinylidene difluoride (“PVDF”), or any suitable thermoplastic fluoropolymer.

In addition to the higher-melt component and the lower-melt component, in some embodiments, the adhesive 104 includes other components. One suitable additional component is a particulate conductive filler, such as carbon black, graphite, metal, metal oxide, conductive coated glass or ceramic beads, particulate conductive polymer, or a combination of these. Such particulate fillers are in the form of powder, beads, flakes, fibers, or any other suitable form. Other suitable components are antioxidants, inert fillers, nonconductive fillers, radiation crosslinking agents (often referred to as prorads or crosslinking enhancers), stabilizers, dispersing agents, coupling agents, pigments, acid scavengers (for example, CaCO₃), other components, or combinations of these.

### EXAMPLES

Table 1 shows examples of the lower-melt component and the higher-melt component blended to form the adhesive 104. The lower-melt components are low melting point species of the THV (for example, Dyneon™ THV 221 available from 3M, St. Paul, Minn., having a melting point of 115° C. and Dyneon™ THV 2030 available from 3M, St. Paul, Minn., having a melting point of 130° C.). The higher-melt components are fluorinated ethylene-propylene (FEP) (for example, having a melting point of 260° C.), ethylene tetrafluoroethylene (ETFE) (for example, having a melting point of 240° C.), and high melting point species of the THV (for example, Dyneon™ THV 815 available from 3M, St. Paul, Minn., having a melting point of 225° C.).

Testing of adhesion of the adhesive 104 with the fluoropolymer and the aluminum being the substrate 102 using the drum test that is a 90-degree test is shown in Table 1. Examples 1 and 9 are single-component comparative examples. Examples 2-8 and 10-11 show the adhesive having the lower-melt component and the higher-melt component.

TABLE 1

| | | | | | Adhesion | |
|---|---|---|---|---|---|---|
| | Higher-Melt | Higher-Melt | Lower-Melt | Lower-Melt | to | Adhesion to |
| Ex | Component | Concentration | Component | Concentration | Fluoropolymer | Aluminum |
| 1 | None | 0% | THV | 100% | 7.5 | 4.7 |
| | | (by volume) | (MP 115° C.) | (by volume) | (kg/cm) | (kg/cm) |
| 2 | FEP | 20% | THV | 80% | 7.0 | 4.9 |
| | (MP 260° C.) | (by volume) | (MP 115° C.) | (by volume) | (kg/cm) | (kg/cm) |
| 3 | FEP | 30% | THV | 70% | 8.9 | 1.3 |
| | (MP 260° C.) | (by volume) | (MP 115° C.) | (by volume) | (kg/cm) | (kg/cm) |
| 4 | FEP | 50% | THV | 50% | 2.0 | n/a |
| | (MP 260° C.) | (by volume) | (MP 115° C.) | (by volume) | (kg/cm) | |
| 5 | THV | 20% | THV | 80% | 0.53 | 0.35 |
| | (MP 225° C.) | (by volume) | (MP 115° C.) | (by volume) | (kg/cm) | (kg/cm) |
| 6 | THV | 30% | THV | 70% | 0.26 | 0.97 |
| | (MP 225° C.) | (by volume) | (MP 115° C.) | (by volume) | (kg/cm) | (kg/cm) |
| 7 | ETFE | 20% | THV | 80% | 3.8 | 2.4 |
| | (MP 240° C.) | (by volume) | (MP 115° C.) | (by volume) | (kg/cm) | (kg/cm) |
| 8 | ETFE | 30% | THV | 70% | 8.6 | 1.1 |
| | (MP 240° C.) | (by volume) | (MP 115° C.) | (by volume) | (kg/cm) | (kg/cm) |
| 9 | None | 0% | THV | 100% | n/a | 5.5 |
| | | (by volume) | (MP 130° C.) | (by volume) | | (kg/cm) |
| 10 | ETFE | 20% | THV | 80% | 2.2 | 1.5 |
| | (MP 240° C.) | (by volume) | (MP 130° C.) | (by volume) | (kg/cm) | (kg/cm) |
| 11 | ETFE | 30% | THV | 70% | 2.3 | 2.0 |
| | (MP 240° C.) | (by volume) | (MP 130° C.) | (by volume) | (kg/cm) | (kg/cm) |

Examples 2, 3 and 8 showed substantial and unexpectedly strong adhesion. Specifically, Example 2 showed an increase in adhesion on the aluminum in comparison to the single-component adhesive of Example 1. Examples 3 and 8 showed an increase in adhesion on the fluoropolymer in comparison to the single-component adhesive of Example 1. Examples 4-7 and 10-11 did not show an increase in adhesion.

Table 2 shows examples of the lower-melt component and the higher-melt component blended to form the adhesive 104. The lower-melt components are low melting point species of the THV. The higher-melt components are thermoset fluoro elastomers (for example, Viton® F-605C available from DuPont Performance Elastomers, Stow, Ohio having an MP of 200° C.).

Testing of adhesion of the adhesive 104 with the substrate 102 as the aluminum using the lab shear test and the fluoropolymer using the lab peel test that is a 180-degree test is also shown in Table 2. Example 15 is a single-component comparative example. Examples 12-14 and 16-18 show the adhesive having the lower-melt component and the higher-melt component.

TABLE 2

| | | | | | Adhesion | |
|---|---|---|---|---|---|---|
| | Higher-Melt | Higher-Melt | Lower-Melt | Lower-Melt | to | Shear on |
| Ex | Component | Concentration | Component | Concentration | Fluoropolymer | Aluminum |
| 12 | Thermoset | 30% | THV | 70% | 29.92 | 258.85 |
| | Fluoro | (by volume) | (MP 115° C.) | (by volume) | (N/cm) | (N/cm²) |
| | Elastomer | | | | | |
| 13 | Thermoset | 50% | THV | 50% | 42.13 | 178.41 |
| | Fluoro | (by volume) | (MP 115° C.) | (by volume) | (N/cm) | (N/cm²) |
| | Elastomer | | | | | |
| 14 | Thermoset | 70% | THV | 30% | 61.02 | 144.93 |
| | Fluoro | (by volume) | (MP 115° C.) | (by volume) | (N/cm) | (N/cm²) |
| | Elastomer | | | | | |
| 15 | Thermoset | 100% | None | 0% | 45.28 | 41.08 |
| | Fluoro | (by volume) | | (by volume) | (N/cm) | (N/cm²) |
| | Elastomer | | | | | |
| 16 | Thermoset | 30% | THV | 70% | 19.69 | 363.32 |
| | Fluoro | (by volume) | (MP 130° C.) | (by volume) | (N/cm) | (N/cm²) |
| | Elastomer | | | | | |
| 17 | Thermoset | 50% | THV | 50% | 23.62 | 179.65 |
| | Fluoro | (by volume) | (MP 130° C.) | (by volume) | (N/cm) | (N/cm²) |
| | Elastomer | | | | | |
| 18 | Thermoset | 70% | THV | 30% | 51.57 | 125.55 |
| | Fluoro | (by volume) | (MP 130° C.) | (by volume) | (N/cm) | (N/cm²) |
| | Elastomer | | | | | |

Examples 14 and 18 showed increased adhesion to fluoropolymers in comparison to the single-component adhesive of Example 15. Examples 12-14 and 16-18 showed increased adhesion to aluminum in comparison to the single-component adhesive of Example 15.

Table 3 shows examples of the lower-melt component and the higher-melt component blended to form the adhesive 104. The lower-melt components are low melting point species of the EFEP (for example, NEOFLON™ EFEP RP-5000, available from Dakin America, Laramie, Wyo.) and the PVDF. The higher-melt components are fluorinated ethylene-propylene (FEP) (for example, having a melting point of 260° C.).

In Examples 19 through 22, adhesion is tested by blending the lower-melt fluoropolymer with the higher-melt fluoropolymer using a mixer without further drying at a predetermined temperature corresponding to the composition of the blend. The blending is for a period of 5 minutes at 30 revolutions per minute, followed by 10 minutes at 80 revolutions per minute. The blend is formed into a film by compression molding using a 152 mm by 152 mm by 0.6 mm metal picture frame. The films are compressed between two PTFE or polyimide layers and two steel plates at a predetermined temperature and pressure. The films are peeled off of the PTFE/polyimide layers and tested. The samples are assembled by securing about 2.5 centimeter by about 2.5 centimeter samples together, positioning the samples in an oven at a predetermined temperature for 30 minutes, removing the samples, and permitting the samples to cool.

The aluminum substrate is prepared by cleaning a about 15 centimeter aluminum mandrel in a solvent or alkaline solution and etch with a solution having, by volume, 30 parts water, 10 parts sulfuric acid (98%, specific gravity 1.84), and 1 part sodium dichromate. The etching solution temperature is at a temperature of about 62° C. to about 68° C., or about 65° C., and the mandrel is immersed in the solution for 10 minutes, rinsed in water, air-dried at room temperature for 15 minutes, and force dried for 20 minutes in a about 55° C. to about 75° C., or about 65° C., with a mechanical convection oven in which air passes the mandrel at a velocity of about 3000 to about 6000 centimeters per minute. The mandrel is removed from the oven, cooled to room temperature, and used within 2 hours. The polymeric substrate is prepared by lightly abrading heat-shrinkable tubing on the outer diameter with a number 320 emery cloth and wiping with a lint-free cloth or paper towel having isopropyl alcohol.

Shear and peel strength-lab shear and peel tests are performed with about 2.5 centimeter by about 7.5 centimeter by about 0.3 centimeter 6061-T6 aluminum alloy and about 2.5 centimeter by 7.5 centimeter pre-heat recovered heat-shrinkable tubing (RT555). The aluminum and the RT555 are prepared by wiping with isopropanol and air-dried for 15 minutes. Adhesion testing is performed using an Instron 4202 test machine set with a crosshead speed of 10 mm/min, full scale load range of 10 KN, humidity of 50%, and temperature of about 18° C. to about 28° C., or about 23° C. The peel testing is performed with a crosshead speed of 25 mm/min, full scale load range of 10KN, humidity of 50%, and a temperature of about 18° C. to about 28° C., or about 23° C. Peel strength testing is performed using a rolling drum peel test on about a 2.5 cm outer diameter mandrel of 6061-T6 aluminum alloy and an extruded piece of 3.81 centimeter heat-shrinkable tubing per RT555. The samples are tested by mandrels in a rolling drum peel fixture and peel tape from the mandrel, using the peeled backedge, in a suitable tensile test machine such that the tubing peels off at a rate of about 5 cm per minute as the mandrel rotates. The test is conducted at a temperature of 23±2° C., resulting in the values shown in Table 3.

TABLE 3

| | | | | | Adhesion | |
|---|---|---|---|---|---|---|
| | Higher-Melt | Higher-Melt | Lower-Melt | Lower-Melt | to | Shear on |
| Ex | Component | Concentration | Component | Concentration | Fluoropolymer | Aluminum |
| 19 | FEP | 20% | EFEP | 80% | 61.02 | 228.78 |
| | (MP 260° C.) | (by volume) | (MP 195° C.) | (by volume) | (N/cm) | (N/cm²) |
| 20 | FEP | 30% | EFEP | 70% | 32.28 | 144.30 |
| | (MP 260° C.) | (by volume) | (MP 195° C.) | (by volume) | (N/cm) | (N/cm²) |
| 21 | FEP | 20% | PVDF | 80% | n/a | 508.25 |
| | (MP 260° C.) | (by volume) | (MP 145° C.) | (by volume) | | (N/cm²) |
| 22 | FEP | 30% | PVDF | 70% | n/a | 208.94 |
| | (MP 260° C.) | (by volume) | (MP 145° C.) | (by volume) | | (N/cm²) |

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An adhesive composition blend, comprising:
a higher-melt fluoropolymer component having a melting point greater than a predetermined maximum service temperature; and
a lower-melt fluoropolymer component having a melting point less than a predetermined applying temperature;
wherein the melting point of the higher-melt fluoropolymer is at least 20° C. greater than the melting point of the lower-melt fluoropolymer.

2. The adhesive composition blend of claim 1, wherein the lower-melt fluoropolymer component includes THV.

3. The adhesive composition blend of claim 1, wherein the lower-melt fluoropolymer component includes polyvinylidene fluoride.

4. The adhesive composition blend of claim 1, wherein the higher-melt fluoropolymer component includes fluorinated ethylene-propylene.

5. The adhesive composition blend of claim 1, wherein the higher-melt fluoropolymer component includes ethylene tetrafluoroethylene.

6. The adhesive composition blend of claim 1, wherein the melting point of the higher-melt fluoropolymer component is between about 200° C. and about 330° C.

7. The adhesive composition blend of claim 1, wherein the melting point of the lower-melt fluoropolymer component is between about 100° C. and about 260° C.

8. The adhesive composition blend of claim 1, wherein the adhesive composition blend is positioned on aluminum.

9. The adhesive composition blend of claim 8, wherein the adhesive composition blend adheres to the aluminum in response to a force of about 4 kilograms per centimeter.

10. The adhesive composition blend of claim 1, wherein the adhesive composition blend is positioned on a fluoropolymer substrate.

11. The adhesive composition blend of claim 1, wherein the adhesive composition blend is positioned on ethylene tetrafluoroethylene wire.

12. The adhesive composition blend of claim 11, wherein the adhesive composition blend adheres to the ethylene tetrafluoroethylene wire in response to a force of about 7 kilograms per centimeter.

13. The adhesive composition blend of claim 1, wherein the adhesive composition blend is positioned on a tape.

14. The adhesive composition blend of claim 1, wherein the higher-melt fluoropolymer component is at a concentration, by volume, of between about 20% and about 30%.

15. The adhesive composition blend of claim 1, wherein the lower-melt fluoropolymer component is at a concentration, by volume, of between about 70% and about 80%.

16. The adhesive composition blend of claim 1, wherein the adhesive composition blend has dimensional stability at about 250° C.

17. The adhesive composition blend of claim 1, wherein the adhesive composition blend remains substantially devoid of phase separation after eight months at a temperature of about 250° C.

18. The adhesive composition blend of claim 1, wherein the melting point of the higher-melt fluoropolymer component is above about 200° C. and the melting point of the lower-melt fluoropolymer component is below about 200° C.

19. An adhesive composition blend, comprising:
a higher-melt fluoropolymer component having a melting point between about 200° C. and about 330° C.; and
a lower-melt fluoropolymer component having a melting point between about 100° C. and about 260° C.;
wherein the melting point of the higher-melt fluoropolymer is at least 20° C. greater than the melting point of the lower-melt fluoropolymer.

20. An article, comprising:
a substrate; and
an adhesive positioned on the substrate, the adhesive comprising:
a higher-melt fluoropolymer component having a melting point greater than a predetermined maximum service temperature; and
a lower-melt fluoropolymer component having a melting point less than a predetermined applying temperature;
wherein the melting point of the higher-melt fluoropolymer is at least 20° C. greater than the melting point of the lower-melt fluoropolymer.
